(19) United States
(12) Patent Application Publication
(10) Pub. No.: US 2026/0368981 A1
(43) Pub. Date: Nov. 19, 2026

(54) COORDINATING MULTIPLE 360-DEGREE VIDEOS OF OBJECTS

(71) Applicant: GOOGLE LLC, Mountain View, CA (US)

(72) Inventor: Valdrin KOSHI, Brooklyn, NY (US)

(21) Appl. No.: 19/210,502

(22) Filed: May 16, 2025

(51) Int. Cl. G06T 13/20; G06T 19/20

(52) U.S. Cl. CPC G06T 13/20; G06T 19/20; G06T 2219/2016

(57) ABSTRACT

The disclosed embodiments relate to systems/methods of automatically loading and animating multiple 360-degree videos of objects (e.g., merchandise, such as shoes or chairs) rotating continuously about an axis (e.g., y-axis) upon certain conditions. For example, the conditions can include detecting that an image is positioned at a particular scroll point in a viewport of a webpage. Additionally, the method can include coordinating multiple 360-degree videos of objects such that the objects are oriented in the same rotational position at all points of rotation and the rotational speed is the same for all of the objects.

### TECHNICAL FIELD

The embodiments disclosed are related to loading and displaying 360-degree videos of objects on a webpage. More specifically, the embodiments are related to coordinating the multiple 360-degree videos to load and display at certain positions on a viewport of a website.

### BACKGROUND

Providing a user experience on a website can be affected by many factors. For example, the number of images on a viewport, the position of the images, and/or the size of the images on the viewport can impact the user’s ability to absorb the information before them. In advertising on the Internet, merchandising images of objects (e.g., consumer goods) can impact how the objects appeal to customers. It is beneficial if the layout of the images allows the user to visually consume the objects and information about the objects without becoming overwhelmed. Users often want to know more about the object they are considering buying and users want to be able to easily compare objects. User interfaces sometimes allow users to view images of different perspectives of the objects. However, user interfaces typically require a user to provide precise user input (e.g., mouse or touchpad movements) to select different images showing different perspectives of the objects or to manually rotate an image to view different perspectives of the objects.

There is a need in the art for a system and method that addresses the shortcomings discussed above.

### SUMMARY

In one aspect, the disclosure provides a computer-implemented method of coordinating multiple 360-degree videos of objects. The method can include obtaining one or more input images and/or 3-dimensional models of multiple objects. The method can include, based on the one or more input images and/or 3-dimensional models of multiple objects, generating multiple 360-degree videos, each 360-degree video showing an individual object of the multiple objects rotating about an axis. The method can include displaying, on a webpage, multiple instances each displaying a static image of an individual object of the multiple objects. The method can include detecting that a first set of instances of the multiple instances are in a first position in a viewport of the webpage. The method can include, responsive to detecting that the first set of instances are in a first position in the viewport, automatically loading and animating a first set of generated 360-degree videos of the 360-degree generated videos in place of the static images in the first set of instances.

In another aspect, the disclosure provides a system for coordinating multiple 360-degree videos of objects, including one or more computers and one or more storage devices storing instructions. The instructions can be executable to by the one or more computers to perform the following: obtain one or more input images and/or 3-dimensional models of multiple objects; based on the one or more input images and/or 3-dimensional models of multiple objects, generate multiple 360-degree videos, each 360-degree video showing an individual object of the multiple objects rotating about an axis; display, on a webpage, multiple instances each displaying a static image of an individual object of the multiple objects; detect that a first set of instances of the multiple instances are in a first position in a viewport of the webpage; and responsive to detecting that the first set of instances are in a first position in the viewport, automatically load and animate a first set of generated 360-degree videos of the 360-degree generated videos in place of the static images in the first set of instances

In yet another aspect, the disclosure provides a non-transitory computer-readable medium storing software comprising instructions that are executable by one or more computers coordinate multiple 360-degree videos of objects by: obtaining one or more input images and/or 3-dimensional models of multiple objects; based on the one or more input images and/or 3-dimensional models of multiple objects, generating multiple 360-degree videos, each 360-degree video showing an individual object of the multiple objects rotating about an axis; displaying, on a webpage, multiple instances each displaying a static image of an individual object of the multiple objects; detecting that a first set of instances of the multiple instances are in a first position in a viewport of the webpage; and responsive to detecting that the first set of instances are in a first position in the viewport, automatically loading and animating a first set of generated 360-degree videos of the 360-degree generated videos in place of the static images in the first set of instances.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a system for coordinating multiple videos of objects, according to an embodiment.

FIG. 2 shows an example of 12 images of a shoe 200 depicted in various views, according to an embodiment.

FIG. 3 shows user device advertisements in a first scroll position, according to an embodiment.

FIG. 4 shows user device with the advertisements from FIG. 3 in a second scroll position, according to an embodiment.

FIG. 5 shows user device with the advertisements from FIG. 4 in a third scroll position, according to an embodiment.

FIG. 6 shows an alternative display for the scroll position shown in FIG. 4, according to an embodiment.

FIG. 7 shows the display of FIG. 6 scrolled down to a fourth position, according to an embodiment.

FIG. 8 shows a computer-implemented method of for coordinating multiple videos of objects, according to an embodiment.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### DESCRIPTION OF EMBODIMENTS

The disclosed embodiments can enhance a user experience of viewing merchandise on a webpage. For example, a webpage can be displayed on a screen of a user device. Upon predetermined conditions, multiple 360-degree videos of objects (e.g., merchandise, such as shoes or chairs) can be automatically loaded on the webpage and animated. The 360-degree videos can show the objects rotating continuously about an axis (e.g., y-axis). In one example, a condition can include detecting that an instance is located at a particular scroll point in the viewport of a webpage. Additionally, the method can include coordinating multiple 360-degree videos of objects such that the objects are oriented in the same rotational position at all points of rotation and the rotational speed is the same for all of the objects.

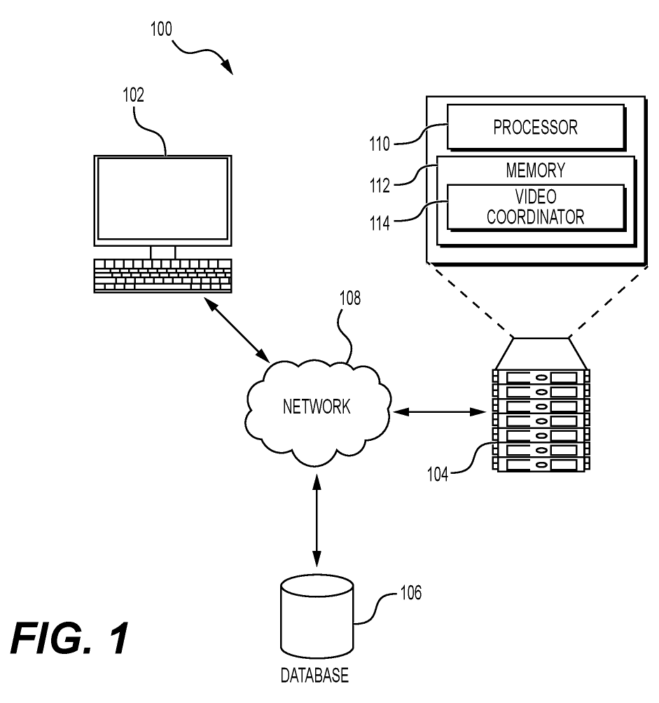

FIG. 1 is a schematic diagram of a system for coordinating multiple 360-degree videos of objects 100 (or system 100), according to an embodiment. During use, a user may interact with the system to scroll a webpage. The disclosed system may include a plurality of components capable of performing the disclosed computer implemented method. For example, system 100 includes a user device 102, a computing system 104, and a database 106. Database 106 may store information training data.

The components of system 100 can communicate with each other through a communication network 108. For example, user device 102 may retrieve training data from database 106 via communication network 108. In some embodiments, communication network 108 may be a wide area network ("WAN"), e.g., the Internet. In other embodiments, communication network 108 may be a local area network ("LAN").

While FIG. 1 shows one user device, it is understood that one or more user devices may be used. For example, in some embodiments, the system may include two or three user devices. In some embodiments, the user devices may be computing devices used by a user. For example, user device 102 may include a smartphone or a tablet computer. In other examples, user device 102 may include a laptop computer, a desktop computer, and/or another type of computing device. The user devices may be used for inputting, processing, and displaying information. In some embodiments, a digital camera may be used to generate images used for analysis in the disclosed method. In some embodiments, the user device may include a digital camera that is separate from the computing device. In other embodiments, the user device may include a digital camera that is integral with the computing device, such as a camera on a smartphone or tablet.

As shown in FIG. 1, in some embodiments, a video coordinator 114 can be hosted in a computing system 104. Processor 110 can include a single device processor located on a single device, or it can include multiple device processors located on one or more physical devices. Memory 112 can include any type of storage, which can be physically located on one physical device, or on multiple physical devices. In some cases, computing system 104 can comprise one or more servers that are used to host the system.

While FIG. 1 shows a single user device, it is understood that more user devices can be used. For example, in some embodiments, the system can include two or three user devices.

While FIG. 1 shows a smartphone, it is understood that other devices can be used in place of a smartphone. For example, a laptop computer, desktop computer, tablet computer, or other type of computing device can be used in place of a smartphone. The user device can be a computing device used by a user for communicating with the system and for displaying images/videos in accordance with the disclosed method.

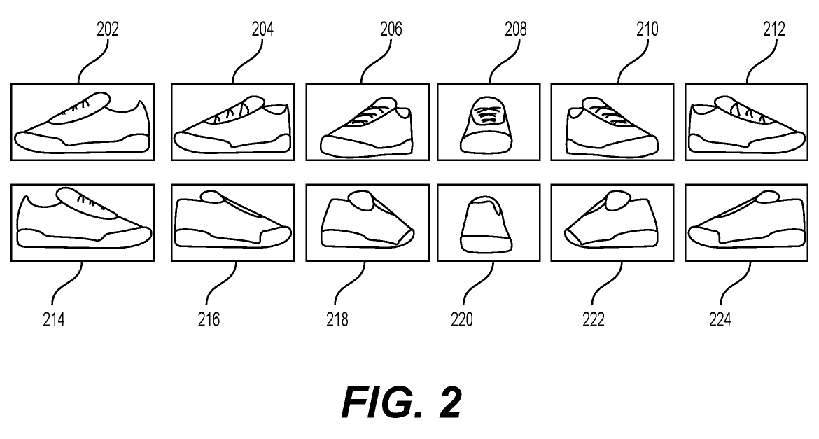

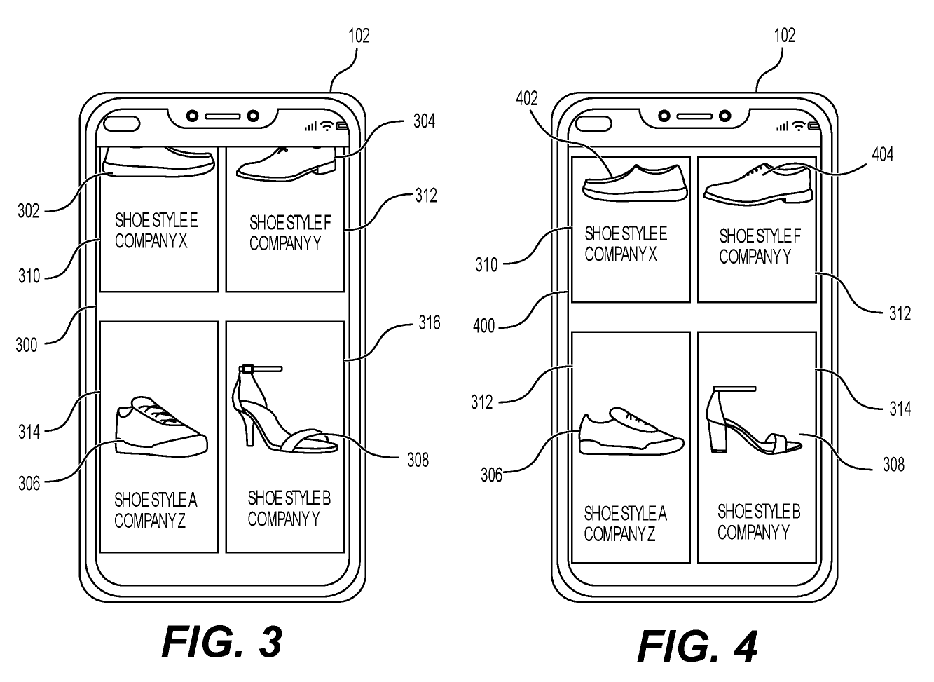

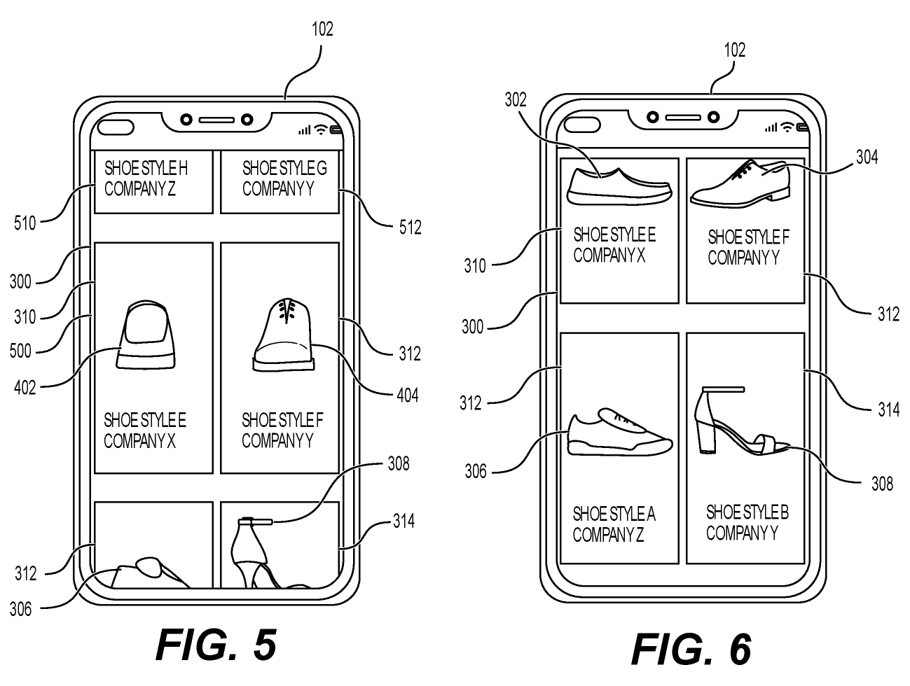

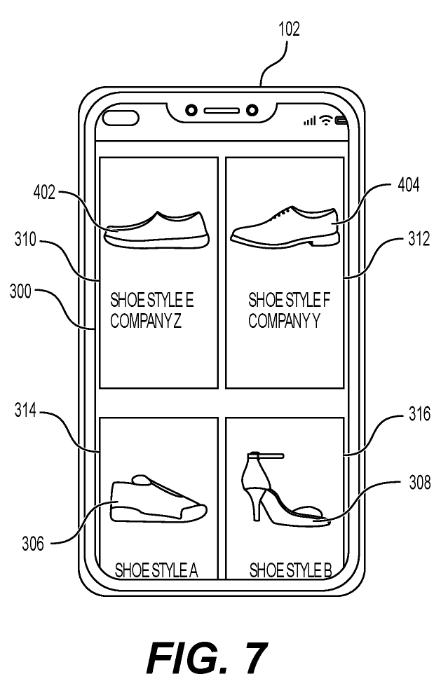

FIG. 2, described below in more detail, provides an example of generated images each rotated 30 degrees with respect to the previous image. FIGS. 3-7 show schematics and images of a display screen with a graphical user interface, according to an embodiment. FIGS. 3-5 show different scroll positions of images as the screen is scrolled from a first position in FIG. 3 down to a second position in FIG. 4, and then scrolled further down to a third position in FIG. 5. FIG. 6 shows an alternative display for the scroll position shown in FIG. 4. FIG. 7 shows the display of FIG. 6 scrolled down to a fourth position.

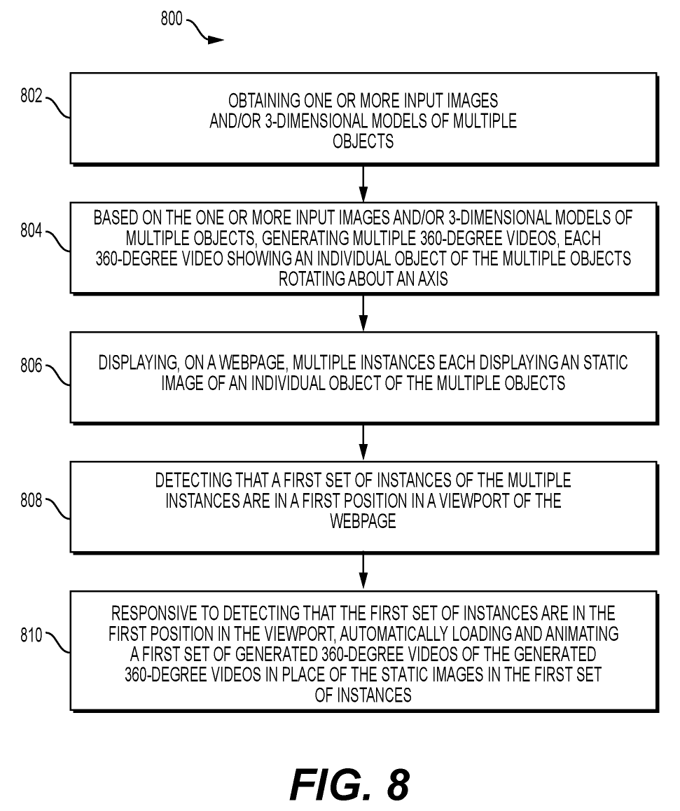

FIG. 8 shows a computer-implemented method of for coordinating multiple videos of objects, according to an embodiment. The method can include obtaining one or more input images and/or 3-dimensional models of multiple objects (operation 802). For example, a 3-dimensional model of a first object can be received from a merchant or other third party or retrieved from a database. In another example, 3 static images of a second object can be received from a merchant or other third party or retrieved from a database.

The method can include, based on the one or more input images and/or 3-dimensional models of multiple objects, generating multiple 360-degree videos, each 360-degree video showing an individual object of the multiple objects rotating about an axis (operation 804). For example, the 3-dimensional model can be used to generate multiple 2-dimensional static images of the first object. The 3 static images of the second object can be used to generate more static images. For example, referring to the various rotational positions of shoes shown in FIG. 2, described in more detail below, the 3 static images can include image 202, image 204, and image 208. These multiple static images can be used to generate image 206, image, 210, image 212, image 215, image 216, image 218, image 220, image 222, image 224.

The goal of the static images each having different views is to provide views that can be displayed in quick succession, in a flipbook fashion, to create a video. Each image can show the object rotated 30 degrees about a y-axis with respect to the object’s position in the previous image. FIG. 2, described below in more detail, provides an example of generated images each rotated 30 degrees with respect to the previous image. Displaying the multiple images one at a time, one replacing the next, in quick succession can provide the same effect as a video showing the object rotating 360 degrees about a y-axis.

It is understood that “video” in the context of this specification includes displaying images in quick succession like this to give the impression of movement of the object. It is also understood that a “360-degree video” in the context of this specification includes displaying images of an object in different rotational positions in quick succession to give the impression of the object spinning 360 degrees. In some embodiments, a 360-degree video can include displaying images of an object in different rotational positions in quick succession to give the impression of the object spinning substantially 360 degrees. For example, substantially 360 degrees can include a range from 270 degrees to 360 degrees. In another example, substantially 360 degrees can include a range from 350 degrees to 359 degrees.

In some embodiments, the method can include obtaining a video of an object rotating through every degree of 360 degrees. In such an embodiment, the obtained video can be compressed to a 360-degree video in which only three to 24 static images show the object in various rotational positions. This operation can be similar to generating static images from a 3-dimensional model, as discussed above.

As mentioned, multiple rotational orientations can be generated from various sources. A 3-dimensional model can be a highly informative source, but a 3-dimensional model also requires more resources to produce than static images require. The disclosed method can be cost effective because as few as 3 simple static images of an object can be transformed into as many as 24 or more static images.

By generating individual images of objects in multiple rotational orientations, time, memory, and computing resources can be saved in comparison with generating a continuous video showing every single rotational orientation of the object occurring in a 360-degree rotation of the object. For example, storing 12 images, or even 24 images, requires much less memory than storing a continuous video showing every single rotational orientation of the object occurring in a 360-degree rotation of the object. Less memory also means faster loading on a webpage. For example, loading 24 images is much faster (e.g., 200-300 kilobytes) than loading an entire 3-dimensional model (e.g., 3 or 4 megabytes) or a video of the object rotating through every degree of 360 degrees. A browser has a limited amount of network speed that can be used to load a page. This reduction in memory and increase in speed becomes more important when a webpage includes more images and/or text from other sources. The reduction in memory and increase in speed can be more noticeable in a complex webpage where displayed instances are competing with one another for network speed to be loaded.

In a situation where a merchant provides as few as 3 images of a product, the disclosed method can convert the 3 images to a 360-degree video. In other words, the disclosed method can convert the 3 images into a richer image with a more interactive experience for a user (consumer).

Additionally, providing several views of the object in various rotational positions can make it easier to synchronize multiple videos. For example, the videos can be synchronized by simply instructing each video to start on video frame 0 and end on video frame 12. Such synchronization can make for smoother animation. As previously mentioned, an anchor can be selected to control animation of the videos. In an example, if the anchor point is the middle of the viewport, the videos can be instructed to show video frame 6 of each video when the same video reaches the middle of the viewport.

FIG. 2 shows an example of 12 images of a shoe 200 depicted in various views. A 360-degree video can include these 12 images as 12 video frames of the video, respectively. From left to right, each view of shoe 200 is rotated 30 degrees about a y-axis with respect to the shoe’s position in the previous image. For example, image 202 is a lateral side view of shoe 200. Image 202 can be considered “video frame 1” in the context of coordinating the display of the generated images. Image 204 is a view of shoe rotated 30 degrees about a y-axis with respect to the shoe’s position in image 202. Image 204 can be considered “video frame 2” in the context of coordinating the display of the generated images. Image 206 is a view of shoe rotated 30 degrees about a y-axis with respect to the shoe’s position in image 204. Image 206 can be considered “video frame 3” in the context of coordinating the display of the generated images. Image 208 is a view of shoe rotated 30 degrees about a y-axis with respect to the shoe’s position in image 206. Image 208 can be considered “video frame 4” in the context of coordinating the display of the generated images. Image 210 is a view of shoe rotated 30 degrees about a y-axis with respect to the shoe’s position in image 208. Image 210 can be considered “video frame 5” in the context of coordinating the display of the generated images. Image 212 is a view of shoe rotated 30 degrees about a y-axis with respect to the shoe’s position in image 210. Image 212 can be considered “video frame 6” in the context of coordinating the display of the generated images.

Image 214 is a view of shoe rotated 30 degrees about a y-axis with respect to the shoe’s position in image 212. Image 214 can be considered “video frame 7” in the context of coordinating the display of the generated images. Image 216 is a view of shoe rotated 30 degrees about a y-axis with respect to the shoe’s position in image 214. Image 216 can be considered “video frame 8” in the context of coordinating the display of the generated images. Image 218 is a view of shoe rotated 30 degrees about a y-axis with respect to the shoe’s position in image 216. Image 218 can be considered “video frame 9” in the context of coordinating the display of the generated images. Image 220 is a view of shoe rotated 30 degrees about a y-axis with respect to the shoe’s position in image 218. Image 220 can be considered “video frame 10” in the context of coordinating the display of the generated images. Image 222 is a view of shoe rotated 30 degrees about a y-axis with respect to the shoe’s position in image 220. Image 222 can be considered “video frame 11” in the context of coordinating the display of the generated images. Image 224 is a view of shoe rotated 30 degrees about a y-axis with respect to the shoe’s position in image 222. Image 224 can be considered “video frame 12” in the context of coordinating the display of the generated images.

It is understood that the shoe is just an example of an object and that any type of object can be used in this manner. For example, the object can include another consumer product, such as a chair, vehicle, bicycle, or smartphone. It is also understood that while 30 degrees of rotation is shown, the generated images can differ by other degrees of rotation. For example, in some embodiments, six images each differing by 60 degrees of rotation can be generated from the received/obtained 3-dimensional model or received/obtained images. In another example, in some embodiments, 24 images each differing by 15 degrees of rotation can be generated from the received/obtained 3-dimensional model or received/obtained images. The number of generated images can be selected based on the desired speed of animation and/or the desired memory usage. While rotation about the y-axis is shown, the rotation can include rotation about any axis. For example, in some embodiments, the axis can include an x-axis or z-axis.

In some embodiments, generating images of objects in multiple rotational orientations can be performed by a variety of methods. For example, in some embodiments, generating images of objects in multiple rotational orientations can be performed by applying generative artificial intelligence.

In some embodiments, the 360-degree video of an object can be loaded when the poster image of the object is in the viewport or is close to the viewport. As mentioned above, a browser has a limited amount of network speed that can be used to load a page. Loading the 360-degree video of an object only when a user can see it can avoid latency or clogging the network. The animation of the 360-degree video can be controlled based on logic with a certain attrition or coefficient on the vertical axis (y-axis), horizontal axis (x-axis), or other customizations. Once the webpage has been scrolled to a position where the 360-degree video has left the viewport, the 360-degree video can be unloaded from the source to allow the browser to have more cycles and resources to handle displaying instances on the rest of the page. For example, in some cases, the rest of the webpage will show instances from other sources, which can complicate the number of resources available for the webpage.

Time and computing resources can be saved by only loading and animating360-degree videos that are within the viewport. If a user scrolls the page so quickly that an instance including a static image (e.g., poster image) leaves the viewport faster than the length of loading, buffering, and animating the video, the static image can continue to be displayed instead of the animated video. For example, the method can include determining a transition speed of replacing a static image with a 360-degree video and a quantity of video frames in the 360-degree video. The method can further include calculating from the determined transition speed of replacing a static image with a 360-degree video and a quantity of video frames in the 360-degree video, an amount of time that the first instance will be in the viewport and how many frames of the 360-degree video can be displayed in the calculated amount of time. The method can include, responsive to calculating that a predetermined number of frames of the 360-degree video cannot be displayed in the calculated amount of time, continuing to display the static image while refraining from loading and animating the 360-degree video in the viewport. The method can include, responsive to calculating that a predetermined number of frames of the 360-degree video can be displayed in the calculated amount of time, loading and animating the first generated 360-degree video in the viewport.

Time and computing resources can be saved by discarding videos corresponding to instances that have left the viewport. Time and computing resources can also be saved by only loading videos corresponding to instances that are close to being in the viewport. For example, in some embodiments, the 360-degree video can be loaded just before the static image arrives in the viewport.

The method can include displaying, on a webpage, multiple instances each displaying an instance image of an individual object of the multiple objects (operation 806). For example, FIG. 3 shows user device 102 with a screen on which a first shoe advertisement 310, a second advertisement 312, a third advertisement 314, and a fourth advertisement 316 are displayed on a viewport 300 of a webpage. Each of the static images and 360-degree videos can be considered an instance on the webpage. FIG. 3 shows the advertisements in a first scroll position. Each advertisement is displayed within a box containing a static image or 360-degree video of individual shoe and text describing information about the shoe.

FIGS. 3-4 show an example of a poster image being seamlessly replaced by a 360-degree video in response to detecting that the poster image is fully in the viewport. First shoe advertisement 310 includes first static image 302 in which a first shoe is shown in a lateral view. In the first scroll position, first static image 302 is entering viewport 300 and has not yet fully entered viewport 300. Second advertisement 312 includes a second static image 304 in which a second shoe is shown in a perspective view. In the first scroll position, first static image 302 is entering viewport 300 and has not yet fully entered viewport 300.

The rotational position of the first shoe in first static image 302 is different from the rotational position of the second shoe in second static image 304. In some embodiments, the first static image 302 and the second static image 304 entering the viewport can be the poster (or advertising) image provided by a merchant. The poster image in this embodiment is not replaced by a 360-degree video until the poster image is fully in view. Thus, the partially visible shoe images (i.e., first static image 302 and second static image 304) are not yet replaced by a 360-degree video in FIG. 3.

Third advertisement 314 and fourth advertisement 316 are both fully in viewport 300 in the first scroll position. Thus, at the first scroll position, any poster images in third advertisement 314 and fourth advertisement 316 have already been replaced by 360-degree videos. Third advertisement 314 includes a first 360-degree video 306 of a third shoe. Fourth advertisement 316 includes a second 360-degree video 308 of a third shoe. The 360-degree videos play in unison such that the rotational speed and position of the third shoe matches the rotational speed and position of the fourth shoe. FIG. 3 captures the third and fourth shoes as they rotate to the perspective view.

FIG. 4 shows user device 102 with the advertisements from FIG. 3 in a second scroll position. The method can include detecting that a first set of instances of the multiple instances are in a first position in a viewport of the webpage (operation 808). In FIG. 4, it has been detected that first static image 302 and the second static image 304 are in a first position in which first static image 302 and the second static image 304 have fully entered the viewport. The method can include responsive to detecting that the first set of instances are in a first position in the viewport, automatically loading and animating a first set of generated videos of the generated videos in place of the instance images in the first set of instances (operation 810). In FIG. 4, responsive to detecting that the static images of the first shoe and second shoe are in a first position in which first static image 302 and the second static image 304 have fully entered the viewport, the static images can be replaced by 360-degree videos of the first shoe and second shoe, respectively.

FIG. 4 shows first static image 302 replaced by a third 360-degree video 402 of the first shoe and second static image 304 replaced by a fourth 360-degree video 404 of the first shoe. FIG. 4 shows first 360-degree video 306 and second 360-degree video 308 at a different point in rotation with respect to their rotational positions in FIG. 3. The rotation of the shoes in the 360-degree videos can be controlled by coordinating loading of the 360-degree videos upon reaching a predetermined position (or anchor point) on the viewport. It is understood that a viewport frame can be selected for this loading. For example, a viewport frame can be selected based on the location on the viewport where the poster images become fully visible within the viewport.

As shown in FIG. 4, once first static image 302 and second static image 304 are fully in viewport 300, third 360-degree video 402 and fourth 360-degree video 404 simultaneously load on the webpage and replace first static image 302 and second static image 304, respectively. In the first video frames of the 360-degree videos, the first shoe and the second shoe are beginning rotation from the same lateral position in FIG. 4. Third 360-degree video 402 and fourth 360-degree video 404 can display the first shoe and the second shoe continuously rotating at the same rotational rate with matching rotational positions. The rotational speed/speed of the 360-degree videos can be selected based on a variety of factors. For example, the rotational speed/speed of the 360-degree videos can be selected based on the amount of space on the viewport that the 360-degree videos cover. The rotational speed/speed of the 360-degree videos can be selected based on a balance of catching a user’s attention while not overwhelming the user with too quick of movement.

FIG. 5 shows user device 102 with the advertisements from FIG. 3 in a third scroll position. This third scroll position demonstrates how an anchor point can be selected on the viewport for controlling the rotational positions in which the objects in the 360-degree videos are oriented. The anchor point (which can be a viewport frame, such as viewport frame zero plus 50%) can be mapped to the video time (e.g., 2s into video a 5s video) and/or the video frame (e.g., frame 6 of a 12-frame video). For example, the static images of the first shoe and second shoe are already fully shown in the viewport and have been replaced by third 360-degree video 402 and fourth 360-degree video 404, respectively. In the third scroll position shown in FIG. 5, third 360-degree video 402 and fourth 360-degree video 404 have reached a middle of the viewport, which has been selected as an anchor point 500 for the rotational positions in the 360-degree videos. Additionally, the front view has been selected as the rotational position corresponding to the anchor point. In other words, third 360-degree video 402 and fourth 360-degree video 404 are positioned facing forward in a front view once third 360-degree video 402 and fourth 360-degree video 404 reach the middle of viewport 300. In this way, the exact rotational position can be controlled by defining which rotational position the objects in the 360-degree videos are in at any predetermined point on the viewport. Since each video frame of the 360-degree video can represent the object in a specific rotational position, the video frame number can be used to set the rotational position.

FIG. 5 shows first 360-degree video 306 and second 360-degree video 308 at a different point in rotation with respect to their rotational positions in FIG. 4 because first 360-degree video 306 and second 360-degree video 308 have continuously run as the webpage has been scrolled from the first scroll position to the third scroll position.

FIG. 6 shows an alternative layout for the second scroll position. In this embodiment, first static image 302 and second static image 304 are fully visible in viewport 300 but have not yet been replaced by 360-degree videos because the anchor point for loading the 360-degree video is different from the anchor point in FIG. 4. FIG. 7 shows the embodiment of FIG. 6 in a fourth scroll position. In FIG. 7, first static image 302 and second static image 304 have reached the anchor point for being replaced by 360-degree videos. Thus, third 360-degree video 402 and fourth 360-degree video 404 simultaneously load on the webpage and replace first static image 302 and second static image 304, respectively. Similar to FIG. 4, the first shoe and the second shoe are beginning rotation in the same lateral position. Third 360-degree video 402 and fourth 360-degree video 404 can display the first shoe and the second shoe continuously rotating at the same rotational rate in unison with matching rotational positions.

While embodiments are shown with only two videos coordinated together, it is understood that more than two videos can be coordinated in the disclosed manner. For example, three to upward of 12 videos can be coordinated in the disclosed manner.

Embodiments can include a non-transitory computer-readable medium (CRM) storing software comprising instructions executable by one or more computers which, upon such execution, cause the one or more computers to perform the disclosed methods. Non-transitory CRM can refer to a CRM that stores data for short periods or in the presence of power such as a memory device or Random Access Memory (RAM). For example, a non-transitory computer-readable medium can include storage components, such as, a hard disk (e.g., a magnetic disk, an optical disk, a magneto-optic disk, and/or a solid-state disk), a compact disc (CD), a digital versatile disc (DVD), a floppy disk, a cartridge, and/or a magnetic tape.

Embodiments can also include one or more computers and one or more storage devices storing instructions that are operable, when executed by the one or more computers, to cause the one or more computers to perform the disclosed methods.

Certain embodiments can use cloud computing environments. Cloud computing environments can include, for example, an environment that hosts the services for impact analysis and detection described herein. The cloud computing environment can provide computation, software, data access, storage, etc. services that do not require end-user knowledge of a physical location and configuration of system(s) and/or device(s) that hosts the impact analysis and detection services. For example, a cloud computing environment can include a group of computing resources (referred to collectively as “computing resources” and individually as “computing resource”).

While this specification contains many specifics, these should not be construed as limitations on the scope of the disclosure or of what can be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features can be described above as acting in certain combinations and even initially claimed as such, one or more features from a claimed combination can in some examples be excised from the combination, and the claimed combination can be directed to a sub-combination or variation of a sub-combination.

While various embodiments of the disclosure have been described, the description is intended to be exemplary, rather than limiting and it will be apparent to those of ordinary skill in the art that many more embodiments and implementations are possible that are within the scope of the disclosure. Various modifications and changes can be made within the scope of this disclosure.

We claim:

1. A computer-implemented method of coordinating multiple 360-degree videos of objects, comprising:
obtaining one or more input images and/or 3-dimensional models of multiple objects;
based on the one or more input images and/or 3-dimensional models of multiple objects, generating multiple 360-degree videos, each 360-degree video showing an individual object of the multiple objects rotating about an axis;
displaying, on a webpage, multiple instances each displaying a static image of an individual object of the multiple objects;
detecting that a first set of instances of the multiple instances are in a first position in a viewport of the webpage; and
responsive to detecting that the first set of instances are in a first position in the viewport, automatically loading and animating a first set of generated 360-degree videos of the 360-degree generated videos in place of the static images in the first set of instances.

2. The computer-implemented method of claim 1, wherein animating the 360-degree video includes displaying images of an individual object of the multiple objects in different rotational positions in quick succession to create an impression of the individual objects spinning substantially 360 degrees.

3. The computer-implemented method of claim 1, further comprising:
detecting that first set of instances are exiting the viewport; and
responsive to detecting that first set of instances are exiting the viewport, automatically discarding the first set of generated videos.

4. The computer-implemented method of claim 1, wherein the axis is a y-axis.

5. The computer-implemented method of claim 1, further comprising:
calculating positions of the first set of instances in the viewport and synchronizing animation of the first set of generated videos based on a predetermined anchor point in the viewport.

6. The computer-implemented method of claim 5, wherein the predetermined anchor point is a middle of the viewport.

7. The computer-implemented method of claim 1, further comprising:
determining a transition speed and a quantity of video frames within a first generated 360-degree video corresponding to a first instance of the first set of instances;
calculating from the determined transition speed and the determined quantity of video frames an amount of time that the first instance will be in the viewport and how many frames of the first generated 360-degree video can be displayed in the calculated amount of time; and
responsive to calculating that a predetermined number of frames of the first generated video cannot be displayed in the calculated amount of time, refraining from loading and animating the first generated video in the viewport.

8. The computer-implemented method of claim 1, further comprising:
determining a transition speed of replacing a static image with a 360-degree video and a quantity of video frames within a first generated 360-degree video corresponding to a first instance of the first set of instances;
calculating from the determined transition speed and the determined quantity of frames an amount of time that the first instance will be in the viewport and how many frames of the first generated 360-degree video can be displayed in the calculated amount of time; and
responsive to calculating that a predetermined number of frames of the first generated 360-degree video can be displayed in the calculated amount of time, loading and animating the first generated video in the viewport.

9. A system for coordinating multiple 360-degree videos of objects, comprising:
one or more computers and one or more storage devices storing instructions that are executable by the one or more computers to:
obtain one or more input images and/or 3-dimensional models of multiple objects;
based on the one or more input images and/or 3-dimensional models of multiple objects, generate multiple 360-degree videos, each 360-degree video showing an individual object of the multiple objects rotating about an axis;
display, on a webpage, multiple instances each displaying a static image of an individual object of the multiple objects;
detect that a first set of instances of the multiple instances are in a first position in a viewport of the webpage; and
responsive to detecting that the first set of instances are in a first position in the viewport, automatically load and animate a first set of generated 360-degree videos of the 360-degree generated videos in place of the static images in the first set of instances.

10. The system of claim 9, wherein animating the 360-degree video includes displaying images of an individual object of the multiple objects in different rotational positions in quick succession to create an impression of the individual objects spinning 360 degrees.

11. The system of claim 9, wherein the instructions are further executable by the one or more computers to:
detect that first set of instances are exiting the viewport; and
responsive to detecting that first set of instances are exiting the viewport, automatically discard the first set of generated videos.

12. The system of claim 9, wherein the axis is a y-axis.

13. The system of claim 9, wherein the instructions are further executable by the one or more computers to:
calculate positions of the first set of instances in the viewport and synchronizing animation of the first set of generated videos based on a predetermined anchor point in the viewport.

14. The system of claim 13, wherein the predetermined anchor point is a middle of the viewport.

15. A non-transitory computer-readable medium storing software comprising instructions that are executable by one or more computers coordinate multiple 360-degree videos of objects by:
obtaining one or more input images and/or 3-dimensional models of multiple objects;
based on the one or more input images and/or 3-dimensional models of multiple objects, generating multiple 360-degree videos, each 360-degree video showing an individual object of the multiple objects rotating about an axis;
displaying, on a webpage, multiple instances each displaying a static image of an individual object of the multiple objects;
detecting that a first set of instances of the multiple instances are in a first position in a viewport of the webpage; and
responsive to detecting that the first set of instances are in a first position in the viewport, automatically loading and animating a first set of generated 360-degree videos of the 360-degree generated videos in place of the static images in the first set of instances.

16. The non-transitory computer-readable medium of claim 15, wherein animating the 360-degree video includes displaying images of an individual object of the multiple objects in different rotational positions in quick succession to create an impression of the individual objects spinning 360 degrees.

17. The non-transitory computer-readable medium of claim 15, wherein the instructions are further executable by the one or more computers to:
detect that first set of instances are exiting the viewport; and
responsive to detecting that first set of instances are exiting the viewport, automatically discard the first set of generated videos.

18. The non-transitory computer-readable medium of claim 15, wherein the axis is a y-axis.

19. The non-transitory computer-readable medium of claim 15, wherein the instructions are further executable by the one or more computers to:
calculate positions of the first set of instances in the viewport and synchronizing animation of the first set of generated videos based on a predetermined anchor point in the viewport.

20. The non-transitory computer-readable medium of claim 19, wherein the predetermined anchor point is a middle of the viewport.
